(19) United States
(12) Patent Application Publication
(10) Pub. No.: US 2011/0004244 A1
(43) Pub. Date: Jan. 6, 2011

(54) Vented pacifier

(76) Inventors: Craig E. Brown, Mt. Zion, MO (US); Robert J. Brown, Chesterfield, MO (US)

Correspondence Address: Paul M. Denk, 763 South New Ballas Rd. Ste. 305, St. Louis, MO, 63141, US

(21) Appl. No.: 12/807,028

(22) Filed: Aug. 26, 2010

Related U.S. Application Data
(63) Continuation of application No. 11/880,779, filed on Jul. 24, 2007.
(60) Provisional application No. 60/834,504, filed on Jul. 31, 2006.

(51) Int. Cl. A61J 17/00

(52) U.S. Cl. 606/234

(57) ABSTRACT

The present invention is a pacifier having a non-collapsible aperture within the nipple lengthwise and a vertical aperture crosswise. The pacifier has a superiorly arched nipple upon a guard and opposite the nipple, a tab for grasping. The horizontal aperture extends from the tip of the nipple and through the guard. The horizontal aperture allows the passage of air into and out of the pacifier as an infant breathes and has a rib extending lengthwise that prevents collapse of the aperture. However, as infants salivate when suckling on a pacifier, the vertical aperture permits drainage of saliva, that enters the horizontal aperture, back into the mouth of an infant. The guard has a generally oval shape. Alternatively, the nipple deviates superiorly and close to the proximal end, has recesses for teeth or gums, and a hole in the tab for a strap or keeper.

### CROSS REFERENCE TO RELATED APPLICATION

This continuation patent application claims priority to the non-provisional patent application having Ser. No. 11/880,779, filed Jul. 24, 2007, which claims priority to the provisional patent application having Ser. No. 60/834,504, which was filed on Jul. 31, 2006.

### BACKGROUND OF THE INVENTION

The vented pacifier relates generally to infant care accessories. More specifically, the present invention refers to a hollow pacifier with an internal rib that prevents collapse of the pacifier walls as the pacifier is placed and used in the intraoral cavity and that prevents a vacuum from forming within an infant.

A unique aspect of the present invention is an integral rib within a tubular shaped aperture within the nipple of the pacifier. The aperture starts at the tip and proceeds through the nipple that allows an infant to breath through the pacifier without collapsing the nipple. The configuration of the nipple is such that collapse of the internal aperture is prevented. The shape of the pacifier emulates the shape of the human nipple during breast feeding. The nipple is oval and proximately arch shaped in a superior direction that follows the roofline of an infant's mouth. The present invention emulates the normal human breast and nipple shapes an infant encounters during breast feeding.

Babies, or infants, are also inclined to cry as a way of notifying parents of their needs. At times, the cry of an infant is inappropriate and inconvenient. Parents seek ways to pacify their infants and restore some tranquility to a home or other environment. Also, infants have the instinct to suckle milk from their mothers. Following the suckling instinct, infants will suckle almost anything placed into their mouths particularly items having a nipple shape. When suckling, an infant has a difficult time crying. Pacifiers having a fake nipple are accepted by infants and satisfy the infant, for a time. Also, pacifier use is associated with a significant decrease in sudden infant death syndrome.

Pacifiers generally have three parts: a nipple upon which the infant suckles, a base upon which the nipple attaches, and a tab, or ring, extending from the base that the caregiver can grasp. Many pacifiers through the years have had solid nipples.

A pacifier of any design, whether it be the hollow type, that may have air pressure provided within its interior, because it has apertures, or even the solid to nipple, induces the infant to suckle. When an infant undertakes that type of activity, it obviously creates a vacuum in the mouth due to the constant sucking pressure. In addition, since the mouth cavity is accessible to the nasal cavity, and the ear passages, the vacuum may also generate further problems therein. For example, in the various adjacent intra-oral passages, it has been found through medical study and tests that infections may be generated within the ear canals, when a constant sucking force is applied by the infant, which actually can lead to permanent damage in hearing, as well as ear fluid accumulation, motor skills delay, speech delay, cognitive delay, and other maladies, as a result of the development of this negative pressure. Hence, providing a vented pacifier eliminates the development of any vacuum, at the region of the pacifier, within the mouth, and any of the other passages or canals leading therefrom. It also minimizes ear fluid, speech and motor delays, developmental delays, and other maladies which can occur from fluid in the ear. Hence, medical complications may be alleviated, through the usage of a vented pacifier, the type of this design.

A solid nipple induces an infant to suckle. In suckling, though, an infant creates a vacuum in its mouth and adjacent intra-oral passages. A vacuum within the infant's mouth leads to crying in time, and possibly complications.

Many attempts have been made to provide a pacifier that relieves any vacuums induced during suckling. An early patent to Meinecke, U.S. Pat. No. 652,034, is upon a nipple holder, circa 1900. The '034 patent shows a nipple that appears to be hollow, and then mounts upon a nut that has threadily engaged therein a handle, that incorporates a T-vent. This nipple holder, has a venting structure, but the nipple does not define that its head has any type of an opening therethrough. Nevertheless, a vented type of nipple holder is disclosed that shows a threaded engagement between the handle, and the nut that holds the nipple in place.

The patent to Schmidt, et al, U.S. Pat. No. 1,518,823, shows a combination nipple and pacifier, and the nipple shows an aperture, for allowing fluids to be emptied from the accompanying nursing-bottle. Because, when the nipple is applied or threadily engaged into the pacifier, particularly the blind bore, it has no ability to vent. Hence, this pacifier was not designed for venting.

The patent to Mueller, U.S. Pat. No. 2,824,561, shows a combination infant pacifier and feeding device. This particular pacifier has a vented style. It describes that the longitudinal bore, in combination with the plastic tube, does equalize air pressure in the pacifier body, and this device is more involved with the filling of the pacifier body, such as with syrup, honey, medicines, or the like, and then closed with a stopper. The patent description mentions little about the tube and the bore for venting purposes. Yet, the device will inherently function that way, since it describes these features for purposes of equalizing air pressure in the pacifier body, during usage. This device may collapse when in use.

The patent to Clegg, U.S. Pat. No. 3,426,755, shows a pacifier, used as a medicine feeder. Hence, once again, when all the feeding instrumentation is removed, this device would act as a vented pacifier. But, the patent does not describe venting if the device is used as a pacifier. This device also may collapse during usage.

The patent to Davidson, U.S. Pat. No. 3,610,248, shows a gum exercise device. This is not just a pacifier, but has the cavity therein, where the hollow membrane, has a series of apertures therein, and with the membrane being filled with a hydrophilic plastic material. It does describe that the closure member can be removed, and medication may be located within the cavity, and then re-closed with the closure means, to allow for the delivery of medicines, or the like, to a child. This device also may collapse during usage.

The patent to Lerner, U.S. Pat. No. 4,132,232, shows an integrally molded pacifier for infants. But, it does contain a variety of apertures, so that if the pacifier is inadvertently swallowed, the infant will still be able to breathe through these various apertures. This device also may collapse during usage.

The patent to Hinkle, U.S. Pat. No. 4,896,666, shows a face mask assembly and pacifier that tightly contacts the face of the wearer, and is more useful than being used for nipple purposes, such as during preoperative procedures, when anesthetics are applied. While the pacifier does have at least one aperture therein, this particular aperture functions as a passageway to allow medical gas therethrough, when applying medicines or anesthetics to the patient, or infant patient. This device also may collapse during usage.

The patent to Clayton, U.S. Pat. No. 6,197,044, shows a feeding system and apparatus for infants. While the claim of this device defines an improved pacifier, having the usual nipple and mouth guard, the nipple incorporates an inner lumen that is configured to removably receive a tubular member which provides a passageway for oral fluids to enter into the infant. This device also may collapse during usage.

The patent to Ashton, U.S. Pat. No. 6,454,788, discloses a method and apparatus for oral hydration and medication administration using a pacifier. This apparatus includes a nipple and shield, but incorporates a refillable reservoir, apparently for medication administration. It does incorporate a number of fluid-flowing physiologic gutters for forwarding medication and medical fluids adjacent to the tongue of the user to avoid stimulating the gag reflex. This particular device further includes an access assembly that is removably attached to a flange, and a detachable reservoir for holding liquids that are adapted for connection to the neck of the device, for delivering and administering liquids through the nipple to an infant or young child. This device also may collapse during usage.

The patent to Pechenik, et al., U.S. Pat. No. 6,588,613, shows an infant-feeding nipple, not just a pacifier per se. This device defines a nipple for use with an infant bottle unlike the present invention and that delivers water-based fluids to the child through the nipple. This device also may collapse during usage.

The patent to Williams, et al., U.S. Pat. No. 6,776,157, is upon a medical pacifier and method for use thereof for the induction of anesthesia and other gases to an infant. This device may collapse as well during usage.

The published application to Silver, No. US 2004/0124168, is upon an artificial nipple of integrated structure, for feeding purposes, and apparently has a snap engagement onto a container. The engagement is achieved through its arrangement of grooves and lips. This invention from Silver does not serve as an improved feeding nipple and when it is radially compressed, it does not allow the passage of any fluid therethrough.

Finally, the published application to Avital, No. US2003/0083696 is a standard pacifier, but the back end of its tube section is completely opened for full access to the atmosphere. This device also may collapse during usage.

In the preceding work of these applicants, U.S. Pat. Nos. 5,779,071 and 5,570,796, venting and internal tubes prevent the formation of partial vacuums during suckling and resist spills. The preceding work allows an infant to use a bottle as intended but without generating a vacuum inside the bottle. In the medical literature, vacuums in the mouth and adjacent passages of an infant lead to ear aches and other predicaments. As infants use pacifiers to sooth themselves, pacifiers can induce vacuums and resulting adverse effects upon infants. Preventing vacuums induced by infants suckling provides health benefits to the infant.

The current invention, on the other hand, provides means for venting of a pacifier allowing an infant to breath through the pacifier. The infant need not stretch its mouth or eject the pacifier to breathe. The infant can orient the present invention in any direction and still breathe. The infant does so by grasping recesses for the teeth and the gums upon the nipple of the invention with the inferior offset closer to the distal end of the pacifier. The shape of the nipple deviates superiorly moving distally and has an oval shape to emulate the shape of the breast and the nipple during breast-feeding.

The present art overcomes the limitations of the prior art where a need exists for eliminating vacuum within infants using pacifiers. That is, the art of the present invention, a vented pacifier allows air to pass in and out of a hollow pacifier with a rib running lengthwise through the pacifier, preventing collapse. This eliminates the formation of a vacuum within the mouth and adjacent passages of an infant. The aperture of the present invention permits the passage of air for breathing and allows drainage of incidental saliva from the aperture. The present invention provides for easy cleaning, endures inadvertent chewing, and allows an infant to breathe without removing the pacifier. The pacifier, uniquely withstands compressive forces by the infant's jaws which keeps the venting mechanism of the invention functioning at all times. And the infant is encouraged to suckle upon the present invention as the shape of the pacifier emulates the human breast and nipple during breast-feeding between mother and child.

### SUMMARY OF THE INVENTION

Accordingly, the present invention improves a pacifier by forming a rib within the hollow nipple. This pacifier has a nipple perpendicular to and centered upon a guard. The guard extends beyond the closed lips of a typical infant. The invention has offsets for the teeth and gums of an infant with the inferior offset closer to the distal end of the pacifier. Opposite the nipple, the guard has a tab, or ring, or other means for grasping the pacifier. The major aperture extends from the tip of the nipple towards and then through the guard. A rib is provided, extending the entire length of the pacifier which ensures that the pacifier venting aperture is always open. The major aperture allows the passage of air into and out of the pacifier. However, infants salivate especially when suckling on a pacifier. A vertical aperture intersects the horizontal aperture ahead of the guard. The vertical aperture permits drainage of saliva that enters the horizontal aperture back into the mouth of an infant. The pacifier deviates superiorly at the guard end and then slightly inferiorly at the opposite end, thus emulating the human breast anatomy during suckling. The pacifier also has an oval shaped nipple.

The present invention allows for instant and complete movement of air through the pacifier thus allowing the pacifier to remain in place as the infant breathes normally. An infant using the present invention does not create pressure in the mouth or intra-oral cavity. Using the present invention, an ambient or positive pressure arises in the intra-oral cavity that simulates the sensation of breast feeding, a soothing activity for infants. Without creating negative pressure in the intra-oral cavity, pressure remains ambient in the middle ear. Negative pressure, unlike ambient pressure, causes middle ear infections especially shown in non-vented pacifiers. Fluid accumulation in the ear leads to ear infections, as well as developmental, motor, and speech delays in infants still using non-vented pacifiers. Also while using the invention, an infant does not create a negative pressure in the intraoral cavity, air taken in around a pacifier is is minimized and also air ingestion is minimized. In non-vented pacifiers, the infant creates a negative pressure in the intra-oral cavity which generates a pressure gradient that induces an infant to swallow and ingest air. Ingested air often leads to colic, fussiness, reflux, gas, and other gastro-intestinal disorders.

In time, infants begin to outgrow their pacifiers and they must be weaned of the devices. The present invention allows normal breathing by an infant so an infant can alternate readily between a vented pacifier and unassisted breathing. With confidence in breathing, an infant can easily minimize and eventually discontinue use of the vented pacifier. Transitioning easily away from a vented pacifier, an older infant is less likely to place objects in the mouth which promotes healthy formation and alignment of teeth as they grow in. Further, an easy transition from the vented pacifier encourages regular feedings in contrast to snacking which promotes tooth decay.

In the preferred embodiment, the hollow pacifier with a vertical aperture oriented inferiorly or completely through the horizontal aperture is manufactured into the nipple of the invention.

Therefore, it is an object of the invention to provide a new and improved vented pacifier for use by infants.

It is a further object of the present invention to vent continuously and automatically through the invention.

It is a still further object of the present invention to remove promptly any saliva or other liquids that accumulate in the invention.

It is a still further object of the present invention to prevent abnormal suckling by an infant.

It is a still further object of the present invention to prevent abnormal, frequent, and significantly negative pressure non-nutritive suckling by an infant.

It is a still further object of the present invention to prevent disordered, abnormally timed, and irregularly patterned breathing, suckling, or swallowing by an infant.

It is a still further object of the present invention to prevent negative pressure in the middle ear.

It is a still further object of the present invention to prevent formation of fluid in the ear and attending complications.

It is an even still further object of this invention is to prevent rapid air ingestion around the pacifier and its attending complications.

It is a still further object of the present invention to provide for ease of cleaning.

It is a still further object of the present invention to minimize fussiness, air ingestion, reflux, and colic of infants when using the present invention.

It is a still further object of the present invention to provide a location for teeth or gums in an offset position.

Lastly, it is another object of this invention is to prevent leakage of saliva through or around the present invention.

These and other objects may become more apparent to those skilled in the art upon review of the invention as described herein, and upon undertaking a study of the description of its preferred embodiment, when viewed in conjunction with the drawings.

### BRIEF DESCRIPTION OF THE DRAWINGS

In referring to the drawings,

FIG. 1 is a top view of a pacifier vented in accordance with the present invention;

FIG. 2 is a rear view of the present invention;

FIG. 2a is a rear view of an alternate embodiment of the present invention where the opening is partially closed;

FIG. 3 shows a front view of the present invention;

FIG. 4 is a side view of the present invention;

FIG. 5 is a side view of the present invention with the nipple offset;

FIG. 6 is a front view of the nipple offset upwards; and,

FIG. 7 is a top view of the present invention with a tab.

The same reference numerals refer to the same parts throughout the various figures.

### DESCRIPTION OF THE PREFERRED EMBODIMENT

The present invention overcomes the prior art limitations by providing a vented pacifier that provides a non-collapsible aperture to permit continuous and automatic venting as an infant breathes while suckling on the present invention. In referring to the drawings, and in particular FIG. 1, the preferred embodiment of the vented pacifier 1 of this invention is disclosed. The vented pacifier has a tab 1a or ring for grasping the present invention. The tab is located towards the outside of the guard. The guard 2 has a generally oval shape and FIG. 1 shows the edge of the guard. Opposite the tab, the present invention has a nipple 4. The nipple is perpendicular to and centered upon the guard. The nipple has a shape and texture that mimics a human nipple. Generally the nipple is oval shaped in cross section with a narrow neck 10 proximate to the guard. The nipple has the flexibility to move left and right and up and down as an infant chews, moves its jaws, or suckles upon the nipple. In an alternate embodiment, the tab is replaced with a protrusion of a different shape. In an alternate embodiment, the guard has a round or elliptical shape.

Through the center lengthwise, the nipple has a horizontal aperture 6. The horizontal aperture extends from the guard, through the neck, and opens 7 at the opposite end of the nipple. The opening 7 is at the surface of the nipple and may have any diameter, or alternatively may be a slit, series of slits, or other shaped opening. The horizontal aperture has sufficient diameter to aid an infant in breathing. The horizontal aperture cooperates with an opening 3 extending through the guard so that an infant may suckle upon the nipple and breathe through the nipple simultaneously.

The entire length of the horizontal aperture 6 has a rib 6a which prevents closure of the aperture. Approximately one third of the distance from the distal end, the pacifier has a vertical aperture 8 that intersects and is perpendicular to the horizontal aperture. The vertical aperture communicates with the horizontal aperture and drains any saliva or other liquids that enter the horizontal aperture. The vertical aperture 8 is spaced outward from the guard. This spacing clears the lips of an infant suckling upon the nipple and allows drainage of fluids back to the inside of the infant's mouth. The tab is located at the edge of the guard, generally away from the center and on the periphery of the guard.

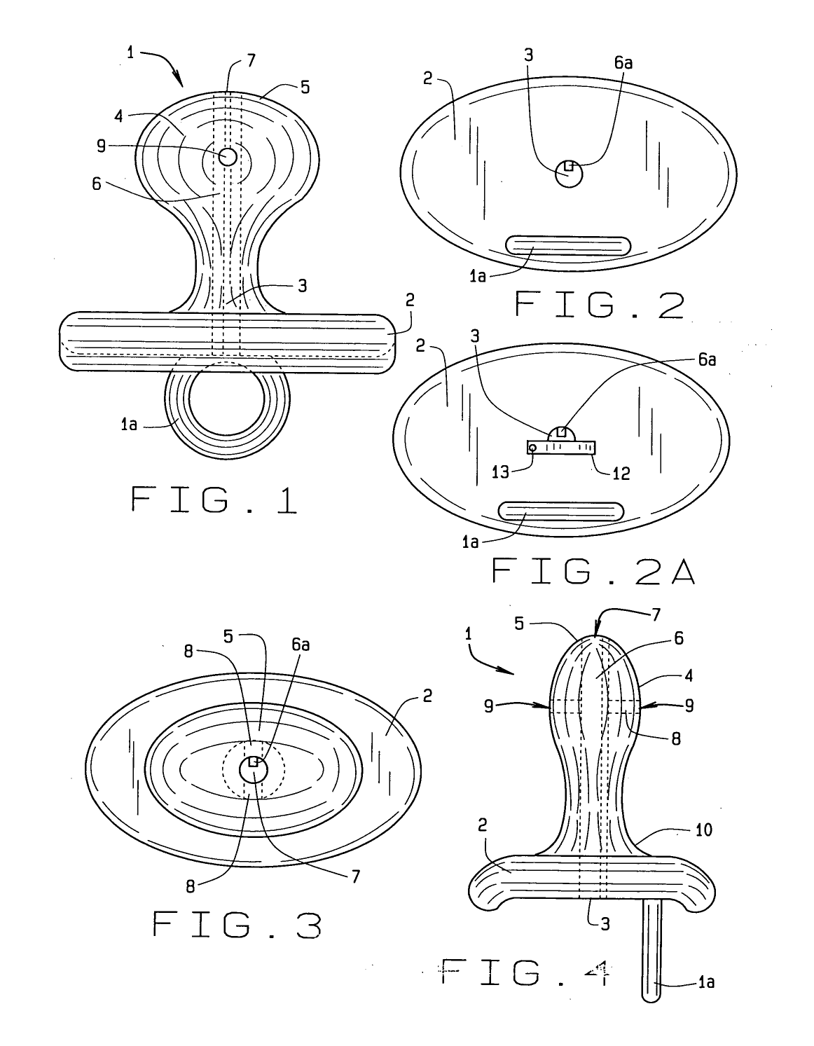

Rotating the vented pacifier, FIG. 2 shows the rear view of the invention, likely as a caregiver would view it. The guard 2 has a generally oval shape having rounded edges for comfort and sufficient length to cover an infant's mouth. The tab 1a extends away from the guard and is perpendicular to the guard, as well as generally on the periphery of the guard and is not easily grasped by the infant, preventing accidental removal from the mouth by an infant, but is easily grasped by a caregiver, an opening 3 communicates to the horizontal aperture 6. The opening also shows an end of the rib 6a that stiffens the horizontal aperture lengthwise which prevents complete collapse of the nipple. Here the rib 6a is shown as rectangular in cross section though other shapes are possible. When an infant compresses the nipple, the rib maintains the horizontal aperture as open for breathing, feeding, and delivery of medicine. As the rib partially divides the tube, breathing by the infant can occur simultaneously with feeding or medicine delivery. Liquid food and medicine can be dispensed to the infant through the horizontal aperture to one side of the rib. The opening 3 introduces air into the nipple that flows onward to the infant.

From time to time, a caregiver may seek to adjust the flow of air through the opening. FIG. 2A shows a rear view of an alternate embodiment where the guard 2 has an oval shape as before along with a ring 1a generally below the opening 3. The opening admits air into the horizontal aperture 6 that has a lengthwise rib 6a as previously described. For air flow regulation, this alternate embodiment has a pivoting bar 12 to one side of the opening. The bar is generally planar and rectangular in shape with two opposite ends. One end of the bar is pivotally connected to the guard, as at 13. The bar has a slight curve lengthwise to temporarily secure the end opposite the pivot in the position selected by the caregiver. The width of the bar is sufficient to completely close the opening so the present invention operates similar to a non-venting pacifier if desired by the caregiver. Though a pivoting bar 12 is described, other devices that partially and then totally close the opening, such as a round turning disc or spiral or nautilus shaped plate, are foreseen.

But the user of the invention would view it as shown in FIG. 3, a front view. An infant would view the guard with the nipple extending perpendicular therefrom. The nipple has a generally oval shape 5 with the exit 7 of the horizontal aperture 6. The oval shape of the nipple emulates the breast shape an infant feels during feeding. The horizontal aperture permits air to enter the opening 3 at the guard and flow through to the exit 7 of the nipple 4. Towards, the distal end, the vertical aperture 8 extends perpendicular to the horizontal aperture 6 and drains the liquid contents, if any, within the horizontal aperture. In use, a caregiver places the vented pacifier 1, nipple first into the mouth of an infant. The infant then suckles on the nipple normally. In suckling, the infant works its mouth and intra-oral passages and thus draws air in through the horizontal aperture 6 maintained open by the rib 6a extending lengthwise in the nipple. The infant can then exhale and inhale through the aperture as desired in normal breathing patterns. A caregiver may also dispense food and medicine through the opening into the horizontal aperture maintained open by the rib.

FIG. 4 shows the side of the vented pacifier, particularly the vertical aperture 8. The vertical aperture extends through the pacifier 1 and the horizontal aperture and communicates outside of the nipple at exits 9. The exits and vertical aperture are located approximately one third of the length of the nipple away from the opening 7. This provides for drainage of excess saliva, which is returned to the oral cavity. The vertical aperture is parallel to the plane of the guard and is on the opposite side of the guard from the tab. This orientation of the vertical aperture permits drainage of saliva and other fluids when the nipple is placed within the infant's mouth. The tab generally has a central opening for securement of a keeper or strap. The strap keeps the pacifier with the infant when the infant releases it from his mouth. Here the nipple is shown wider to reflect the oval cross section.

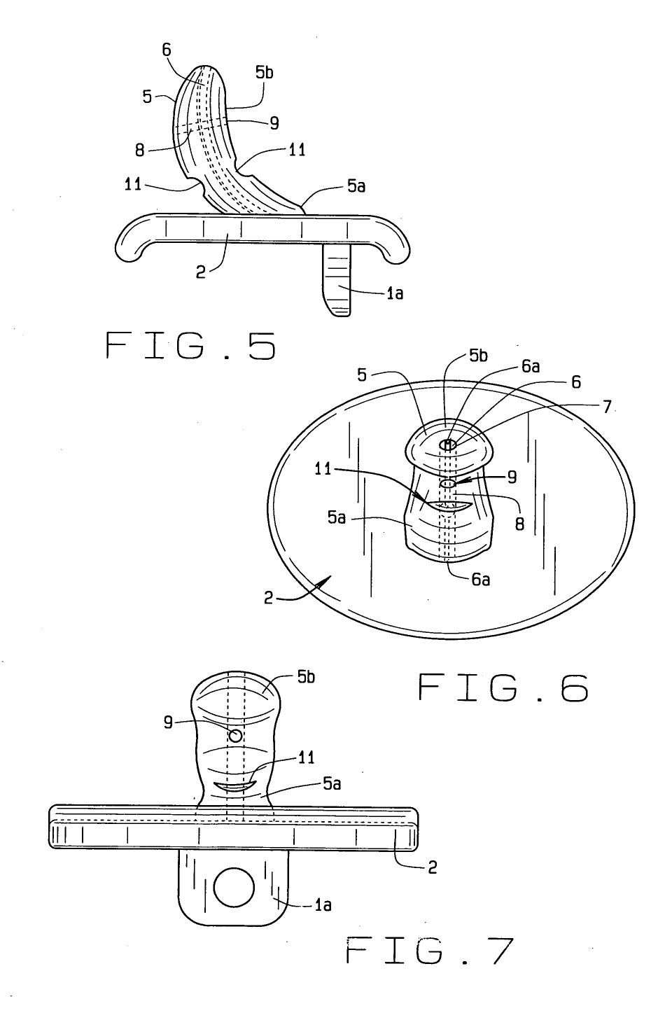

FIG. 5 shows another embodiment of the pacifier from the side. The pacifier has a tab 1a joining to a guard 2 generally below the center towards the edge of the guard. Opposite the tab, the pacifier has a nipple 5 of a somewhat arcuate shape. The nipple deviates superiorly near the guard, shown as 5a, and inferiorly at the free end of the nipple, shown as 5b, thus mimicking the human breast anatomy an infant encounters during feeding. The construction of the nipple allows it to move left and right, up and down, as an infant moves its jaws, chews, and suckles upon the nipple. The nipple has recesses 11 for an infant's gums or teeth, with the inferior recesses slightly more distal than the superior recesses. The recesses 11 are located away from the guard and generally above the center of the guard, and at the 12 and 6 o'clock positions. The recesses engage the infant's gums thus guiding the tab toward the infant's chin which keeps the vertical tube upright for drainage. The recesses extend into the nipple but do not intersect the horizontal aperture 6. As before, the horizontal aperture has a lengthwise rib 6a that prevents complete closure of the horizontal aperture. The horizontal aperture also allows for simultaneous feeding and medicine delivery as the infant breathes through the aperture. The vertical aperture is located between the recesses and the opening 7, generally about one third of the length of the pacifier away from the opening.

Turning the pacifier, FIG. 6 shows the other embodiment from the front as an infant would see it. The pacifier has a guard 2 that extends outwards from the mouth of an infant. The guard has a generally oval shape with the nipple 5 joining to the guard. The nipple joins to the guard, often centrally, as at 5a, then extends outwards and upwards from the guard to the inferiorly located free end, as at 5b. Where the nipple bends to form the free end, the nipple has opposed recesses 11. Here, FIG. 6 shows the lower recess upon which an infant places his gums or teeth when gripping the pacifier. The recesses extend partially across the width of the nipple. As before, the nipple has a horizontal aperture 6 through the length of the nipple that allows passage of air from the opening 7 then into the intra-oral cavity when the pacifier is in usage. The horizontal aperture has a lengthwise rib 6a that prevents closure of the aperture by jaw action of the infant upon the nipple. The horizontal aperture drains through the vertical aperture 8, as shown in FIG. 5, here oriented upright with the lower exit 9 visible.

FIG. 7 shows the other embodiment of the pacifier from above where the pacifier has a guard, generally an oval shaped planar form. The guard has a tab to upon one surface and the nipple upon the opposite surface. The tab joins perpendicular to the guard generally towards the edge so that the tab may be below the nipple during usage. The tab has a central opening, or hole, that provides attachment for a strap or other keeper that connects the pacifier to an infant's clothing to prevent loss of the pacifier when the infant inadvertently removes the pacifier from its mouth. Opposite the tab, the nipple joins to the guard, above the tab. The nipple has a tapering shape to mimic a human nipple. From the guard at 5a, the nipple narrows slightly and extends upwards, or superiorly, and then curves outwards generally horizontally. The nipple widens slightly at the free end 5b. Where the nipple curves between superior and inferior portions, a recess allows an infant to grip the nipple with his or her teeth, or gums. The recess is a depression partially across the width of the nipple. FIG. 7 shows a recess upon the top of the nipple and a matching recess is upon the bottom as previously shown in FIG. 6. The nipple has a horizontal aperture 6 extending lengthwise through the nipple from the guard to the free end. A rib 6a runs the length of the horizontal aperture and prevents complete collapse of the horizontal aperture thus maintaining a flow of air for the infant. The horizontal aperture drains fluids using the vertical aperture 8 here shown on an end with the exit 9.

From the aforementioned description, a vented pacifier has been described. This vented pacifier is uniquely capable of draining fluids, such as saliva, from a breathing aperture within a nipple without impeding air flow through the nipple. This vented pacifier also supports continuous and automatic venting of the oral cavity of an infant during breathing. The vented pacifier prevents collapse of the vent tube and permits introduction of liquids, foods, and medicines through the vent tube and into the oral cavity of an infant during breathing. This vented pacifier and its various components may be manufactured from many materials including but not limited to polymers, low density polyethylene, high density polyethylene, polypropylene, nylon, silicone, ferrous and non-ferrous metals, their alloys, and composites.

Variations or modifications to the subject matter of this invention may occur to those skilled in the art upon reviewing the development as described herein. Such variations, if within the scope of this development, are intended to be encompassed within the principles of this invention, as explained herein. The description of the preferred embodiment, in addition to the depiction within the drawings, are set forth for illustrative purposes only.

We claim:

1. A vented pacifier for infants, to provide for venting and passage of air further inwardly of the mouth, comprising:
a guard having first and second sides and an opening therethrough;
a nipple body extending outwardly from said first side of said guard and sized to fit within the mouth of an infant, said nipple body being a pliable solid with a proximate back end at said guard, a free distal end with an end opening therein, a generally convex upper surface and a bottom surface, and being generally symmetrical from side to side about the longitudinal centerline of said nipple body;
said nipple body including a neck portion nearer said proximate end thereof and nipple head portion nearer said distal end thereof, said neck portion being dimensionally thinner in at least one dimension than said nipple head portion,
a first generally tubular aperture of small diameter extending through said nipple body generally along said longitudinal centerline thereof from said proximate end to said free distal end and forming an end opening in said nipple head portion, said aperture in communication at said proximate end of said nipple body with said opening through said guard, said end opening being further inwardly of the infant's mouth to provide for venting within the oral cavity of the mouth;
said nipple body capable of bending and deforming when manipulated by the mouth of the infant during use of the pacifier;
a single longitudinal rib located within said first generally tubular aperture, extending the full length thereof from said guard to said end opening in said nipple head portion, and sized to act alone and without additional structure to prevent collapse of said first aperture due to pressures exerted on the exterior of said nipple body by the infant and sucking actions of the infant and to maintain at least a minimal free passageway through said first aperture even under such conditions to permit the passage through said aperture of air, liquids, and medicine from said opening in said guard to the mouth of the infant;
a second generally tubular aperture, of a diameter not exceeding the diameter of said first generally tubular aperture, extending generally transverse to said first generally tubular aperture between said top and bottom surfaces of said nipple body to form openings through the top and bottom surfaces at the top and bottom ends of said second generally tubular aperture, said second generally tubular aperture intersecting said first generally tubular aperture and establishing a transverse passageway connected to said first generally tubular aperture for drainage of fluids therethrough into the infant's mouth during use of the pacifier;
said neck portion including recesses along the top and bottom sides thereof to accommodate the teeth and gums of an infant when said nipple body is within the mouth of an infant with the lips of the infant proximate to said guard and sized and positioned along said neck portion to maintain said nipple body within the mouth of the infant with said upper surface of said nipple body proximate to the roof of the infant's mouth and said second generally tubular aperture thus oriented within the infant's mouth to facilitate drainage of fluids therethrough into the bottom of the infant's mouth during use of the pacifier; and a grasping tab connected to said second side of said guard and extending outwardly therefrom.

2. The vented pacifier of claim 1 wherein said nipple body deviates at a curvature along its length.

3. The vented pacifier of claim 2 wherein said curvature effects a top to bottom offset of said end opening in said nipple head portion relative to said opening through said guard.

4. The vented pacifier of claim 1 wherein said grasping tab is connected to said second side of said guard at a location offset from said opening through said guard.

5. The vented pacifier of claim 4 wherein said second side of said guard includes a central generally flat surface portion about said opening through said guard and further comprising:
a cover plate sized and positionable to cover at least a portion of said opening through said guard, a pivotal connection connecting said cover plate to said second side of said guard to allow said cover plate to be rotatably moved about said pivotal connection laterally across said central generally flat surface and said opening to cover and uncover said opening to varying degrees, said cover plate rotatably positionable by a user to a desired position relative to said opening through said guard to control the amount of air to be introduced through said first generally tubular aperture.

6. The vented pacifier of claim 5 wherein said cover plate is a thin bar of a generally plannar and rectangular shape with opposed first and second ends and said first end thereof is connected to said second side of said guard by a pin about which pin said bar is rotatable.

7. A vented pacifier of claim 5 wherein said bar is securable in a desired position by a user.

8. The vented pacifier of claim 5 wherein said cover plate is sized to be able to totally cover said opening through said guard when rotated to one desired position.

9. The vented pacifier of claim 6 wherein said rib has a generally uniform configuration along the entirety of its length.

10. The vented pacifier of claim 1 wherein said nipple head portion is generally bulbous.

11. The vented pacifier of claim 10 wherein said nipple head portion has a generally oval cross-section.
